(19) United States
(12) Patent Application Publication
(10) Pub. No.: US 2007/0107038 A1
(43) Pub. Date: May 10, 2007

(54) Methods and devices for presenting data

(76) Inventor: Martin Aronsson, Lund (SE)

Correspondence Address: MYERS BIGEL SIBLEY & SAJOVEC, P.A., P.O. BOX 37428, RALEIGH, NC, 27627, US

(21) Appl. No.: 11/271,352

(22) Filed: Nov. 10, 2005

(51) Int. Cl. H04N 7/16

(52) U.S. Cl. 725/135; 725/62

(57) ABSTRACT

A method and apparatus enables presentation of complementary data associated with output data presented in an electronic apparatus. The method includes presenting the output data via an output device of the electronic apparatus, obtaining event data associated with the presented output data and based on which the complementary data is obtainable, and submitting the event data to a data presentation unit external to the electronic apparatus. A method and data presentation unit is also provided for presenting complementary data in the data presentation unit. The method includes receiving, from an electronic apparatus located externally to the data presentation unit, event data associated with output data presented in the electronic apparatus. The method also includes obtaining complementary data associated with the output data based on the event data, and presenting the obtained complementary data.

### FIELD OF THE INVENTION

The present invention relates to methods for enabling presentation of data and an electronic apparatus for enabling presentation of data. The present invention also relates to methods for presenting data and a presentation unit for presenting data.

### BACKGROUND OF THE INVENTION

An electronic apparatus may include a display, in which information, menus, applications, etc. may be presented. Furthermore, a help interface, which may present help information for guiding the user on how to operate the electronic device, may be provided in the electronic apparatus.

Providing complementary data, such as a help interface, in an electronic apparatus may be challenging for several reasons. Such a task may be even more challenging if the data should be presented in a portable electronic apparatus, such as a mobile terminal, in which the display may be relatively small. On a relatively small display, it may not be possible to present very much information, if the information is to be legible. Consequently, menus, applications, etc. and/or help interface data may be presented one at a time. Thus, the help interface may have to be entered before the help information can be displayed.

It may be undesirable for the user if it is necessary to enter the help interface each time it is desired to obtain help information. Furthermore, if, for example, the user does not understand the help information correctly after having read it, or if the help information is extensive, and has reverted to the application, the user may have to re-enter the help interface. The procedure may be repeated several times before the user may fully benefit from the help information. Entering and re-entering the help interface may not only be undesirable for the user, it may also consume excess power, which may disadvantageous if the electronic apparatus is battery powered.

Providing an extensive help interface in a portable electronic apparatus may be a problem if the memory capacity is limited. Consequently, it may be necessary to limit the information provided by the help interface. Thus, the help interface may not be as extensive as may be desired to provide a guide on how to operate the electronic apparatus. Consequently, usability of the help interface may be deteriorated.

### SUMMARY OF THE INVENTION

According to some embodiments of the present invention, a method for enabling presentation of complementary data associated with output data presented in an electronic apparatus may include presenting the output data via an output device of the electronic apparatus; obtaining event data associated with the presented output data, wherein the complementary data is obtainable from the event data; and submitting said event data to a data presentation unit external to the electronic apparatus.

In some embodiments, obtaining the event data may include obtaining event data that identifies at least a portion of the presented information and that identifies the complementary data that is stored in a data repository. The data repository may be located externally to the electronic apparatus.

In other embodiments, obtaining the event data may include obtaining event data that is associated with a user application for which the output data is presented.

In some embodiments, obtaining the event data may include obtaining event data that is associated with a menu for which the output data is presented.

In other embodiments, the obtaining the event data may include obtaining event data that includes the complementary data.

According to further embodiments of the present invention, a method for presenting complementary data in a data presentation unit may include receiving, from an electronic apparatus located externally to the data presentation unit, event data that is associated with output data presented in the electronic apparatus; obtaining complementary data that is associated with the output data based on the event data; and presenting the obtained complementary data.

In some embodiments, obtaining complementary data may include obtaining the complementary data from a data repository based on the event data. The event data may include an identifier for identifying the complementary data.

In other embodiments, obtaining complementary data may include obtaining the complementary data from a data repository.

According to other embodiments of the present invention, an electronic apparatus for enabling presentation of complementary data associated with output data may include an output device configured to present the output data; a detector unit configured to detect which output data is currently presented via the output device; and a processing unit configured to obtain event data associated with the presented output data, wherein the complementary data is obtainable from the event data, and configured to submit the event data to a data presentation unit located externally to the electronic apparatus.

In some embodiments, the processing unit may be configured to obtain event data that identifies at least a portion of the presented information and that identifies the complementary data that is stored in a data repository located externally to the electronic apparatus.

In other embodiments, the processing unit may be configured to obtain event data associated with a user application.

In some embodiments, the processing unit may be configured to obtain event data associated with a menu.

In other embodiments, the processing unit may be configured to obtain event data that includes the complementary data.

In some embodiments, the electronic apparatus may be a portable or handheld mobile radio communication equipment, a mobile radio terminal, a mobile telephone, a pager, a communicator, an electronic organizer, and/or a smartphone.

According to still other embodiments of the present invention, a data presentation unit for presenting complementary data may include a communication unit configured to receive, from an electronic apparatus located externally to the data presentation unit, event data associated with output data presented in the electronic apparatus; a data unit configured to obtain complementary data associated with the output data based on the event data; and an output device configured to present the obtained complementary data.

In some embodiments, the data unit may be configured to obtain the complementary data from a data repository based on the event data. The event data may include an identifier for identifying the complementary data.

In other embodiments, the data unit may be adapted to the complementary data from a data repository.

According to yet other embodiments of the present invention, a computer program product may include computer program code configured to carry out a method for enabling presentation of complementary data associated with output data presented in an electronic apparatus. The computer program code may be run by an electronic device having computer capabilities.

According to further embodiments of the present invention, a computer readable medium may have stored thereon a computer program product including computer program code configured to carry out a method for enabling presentation of complementary data associated with output data presented in an electronic apparatus. The computer program code may be run by an electronic device having computer capabilities.

According to still further embodiments of the present invention, a computer program product may include computer program code configured to carry out a method for presenting complementary data in a data presentation unit. The computer program code may be run by an electronic device having computer capabilities.

According to yet further embodiments of the present invention, a computer readable medium may have stored thereon a computer program product including computer program code configured to carry out a method for presenting complementary data in a data presentation unit. The computer program code may be run by an electronic device having computer capabilities.

Further embodiments of the present invention are defined in the dependent claims.

Some embodiments of the present invention may provide methods and electronic devices for enabling presentation of complementary data, which may be associated with output data presented via an output device of an electronic apparatus.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of the invention may be evident from the following detailed description of the invention, with reference being made to the accompanying drawings, in which:

FIG. 1 is a schematic view of an electronic apparatus operatively connected to a data presentation unit according to some embodiments of the present invention;

FIG. 2 is a block diagram of an electronic apparatus according to some embodiments of the present invention;

FIG. 3 is a block diagram of a data presentation unit according to some embodiments of the present invention;

FIG. 4 is a flowchart illustrating exemplary operations in methods for enabling presentation of complementary data according to some embodiments of the present invention; and

FIG. 5 is a flowchart illustrating exemplary operations in methods for presenting complementary data according to some embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention, and is further described in detail below. In the drawings, like numbers refer to like elements.

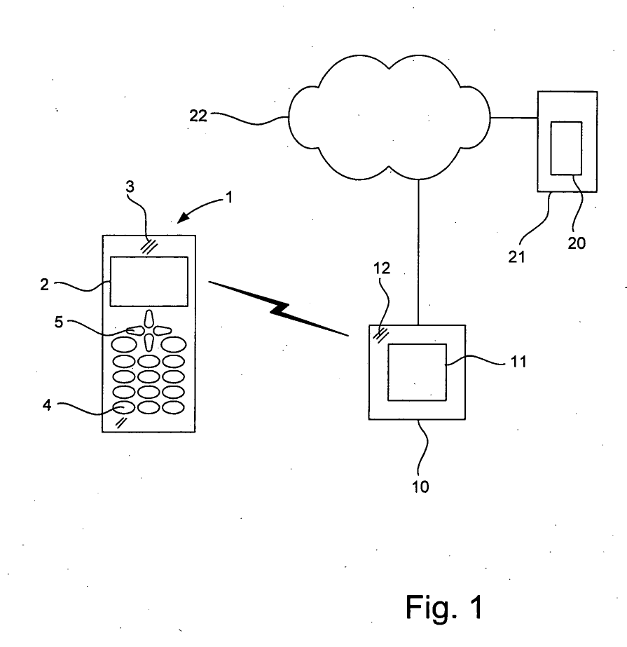

FIG. 1 illustrates an electronic apparatus 1 having at least one output device, such as a display 2 and a loudspeaker 3. The electronic apparatus 1 may also comprise various input devices, such as a keypad 4 and a joystick 5.

The electronic apparatus 1 is operatively connectable to a data presentation unit 10. The data presentation unit 10 comprises at least one output device, such as a display 11 and/or a loudspeaker 12.

Output data may be presented by the output device of the electronic apparatus 1. The output data may, for example, include a graphical user interface (GUI) comprising menus, user applications, etc. The output data may, for example, comprise, text, video, information, sound, music, animated sequences, or combinations thereof. Depending on which output data is presented via the output device of the electronic apparatus 1, event data, which is associated with the presented output data, is obtained. The event data may be submitted to the presentation unit 10. Based on the event data, complementary data, which is associated with the output data, is obtainable. The complementary data is obtained by the data presentation unit 10. Thus, at the same time as output data is presented by the output device of the electronic apparatus 1, the complementary data may be presented by the output device of the presentation unit 1. Consequently, even if the output devices are relatively small displays, such as if the electronic apparatus 1 is a hand held electronic apparatus, the output data and the complementary data may be presented simultaneously. This allows for the provision of, for example, a learning interface or a help interface in the data presentation unit 10 when a user navigates the GUI, e.g., through menus and/or between applications of the electronic apparatus 1.

The complementary data may be data for the help interface. Alternatively, the complementary data may be data for the learning interface. Still another alternative is data for general information associated with the output data presented in the output device of the electronic apparatus. The complementary data is provided to complement the output data currently being presented. Thus, the complementary data is associated with the output data being presented.

The obtaining and submitting the event data may be initiated in dependence of a current mode or context of the electronic apparatus 1. For example, after initial set up (time, date, time zone, etc.) of the electronic apparatus 1, a message may be prompted asking the user whether a “learning” mode should be entered. If the user answers “yes”, complementary data in the form of learning data will be presented by the output device of the presentation unit 10 as the user explores the electronic device 1. The user may explore the electronic device 1 by entering various available user applications and/or menus, such as a communication, a media player, an entertainment, a game, and settings, a camera and an organizer application. The learning data/help data may be information how the electronic apparatus 1 should be operated in the user application/menu, for which output data currently is presented. For example, the user enters the media player menu presented by the output device of the electronic apparatus 1. Then, associated complementary data may be presented by the output device of the presentation unit 10, e.g. in the form of an introductory text about functions of the media player and how to use it.

The obtaining and submitting the event data may also be initiated in response to inserting a removable memory device, such as a memory stick, into the electronic apparatus 1. When the memory device is inserted, the electronic apparatus 1 automatically detects it and prompts a message asking the user whether it is desired to enable presentation of complementary data. Initiation of presentation of complementary data may also be made manually. The event data may be communicated as push data to the presentation unit 10.

As the user enters menus/applications, by e.g. making choices in menus having selectable items presented by the output device of the electronic device 1, complementary data may be continuously presented by the output device of the presentation unit 10.

Obtaining and submitting event data may be initiated manually. For example a help interface may be initiated at any time, wherein complementary data in the form of help information may be provided simultaneously as the user makes choices. Thus, the electronic apparatus 1 may become very simple to operate, as basic instructions how to operate the electronic device 1 may be presented.

The event data comprise an identifier, such as a code, which identifies at least a portion of the information presented by the output device of the electronic apparatus 1. The identifier may, for example, be associated with a certain menu/selectable item of the menu and/or application in that it uniquely identifies it/them. For example, a unique identifier can be provided for all menus/selectable items in a menu/application. The event data in the form of an identifier may be submitted to the presentation unit 10. Then, the presentation unit 10 may obtain from a data repository 20 the complementary data, based on the event data. The identifiers may, for example, be stored in a look-up table provided in the electronic apparatus 1.

The event data may alternatively be data, from which the complementary data is directly obtainable. For example, the event data may be data, which a processor may convert to complementary data that is presentable. For example, the event data may be computer program instructions to be executed by a processor of the presentation unit 10. Thus, when the computer program instructions are executed, the complementary data will be obtained. Still another alternative is that the event data comprises data for controlling the output device of the presentation unit 10. Thus, when the output device of the presentation unit 10 is controlled, the complementary data will be obtained. The event data may be streamed from the electronic apparatus 1 to the data presentation unit 10.

The event data may identify at least a portion of the presented information. Also, the event data may identify the complementary data. The event data may be associated with a user application, for which output data is presented. An identifier may, for example, identify any application that is currently active, i.e. for which output data is currently presented. Alternatively or additionally, the event data may be associated with a menu and/or entries of a menu, for which output data is presented. Still alternatively, the event data may comprise the complementary data, e.g. if the complementary data is directly obtainable from the event data.

The data repository 20 may be a memory device, such as a memory card, a CD (Compact Disc), a DVD (a Digital Video Disc), a hard disk, a ROM (Read Only Memory) etc. The data repository 20 may be located within the presentation unit 10. Alternatively the data repository 20 may be located externally to the presentation unit 10. The data repository may be located at a server device 21. Thus, the complementary data may be downloaded from the server device 21. The server device 21 may be connected to a network 22, through with the complementary data may be downloaded. By downloading the complementary data from the server 22, it may be ascertained that updated complementary data is always accessible. Also, the storage capacity in the electronic apparatus 1 as well as in the presentation device 1 may be reduced. In still an alternative solution, the complementary data is downloaded by the electronic device 1. Downloaded data may then be forwarded to the presentation unit 10. Thus, the downloaded complementary data may be obtainable from the event data communicated to the presentation unit 10.

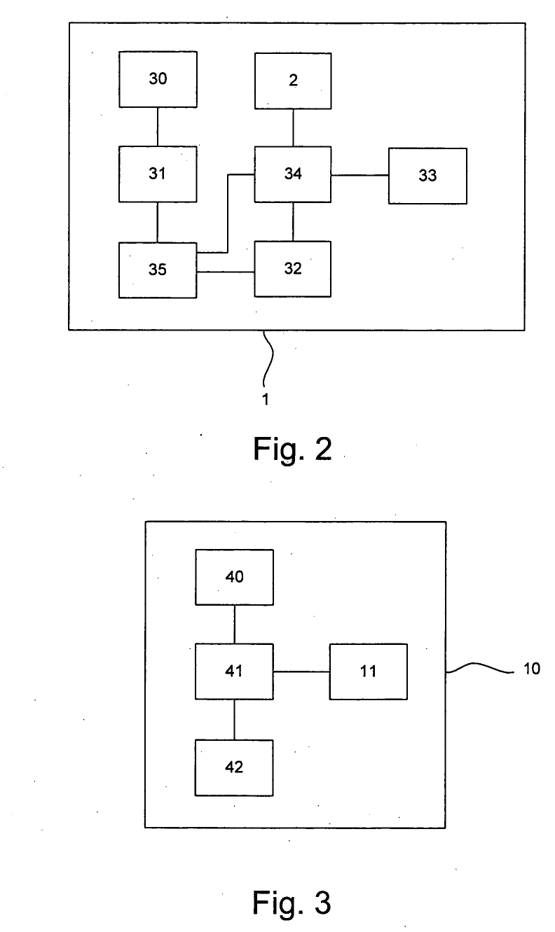

FIG. 2 illustrates some components of the electronic apparatus 1. The electronic apparatus 1 comprises the display 2, a communication unit 30, a detector unit 31, a processing unit 32, an input interface 33, an output data generation unit 34, and a memory 35.

The output data may be presented via the display 2. The output data to be presented may, for example, be generated by the output data generation unit 34. The output data generation unit 34 may, for example, be responsive to the input interface 33. Output data to be presented may be obtained from the memory 35.

The input interface 33 may comprise the keypad 4 and/or the joystick 5.

The detector unit 31 is adapted to detect which output data is currently being presented via the output device. The detector unit 31 may, for example, be adapted to detect an identifier, which uniquely identifies any presented output data. The output data, which is currently presented, may be detected when the output data generation unit 34 updates output data on the screen. The output data generation unit 34 may issue any identifier, which identifies at least a portion of the presented output data. If output data being identified by more than one identifier is currently presented, each identifier may be announced to the detector unit 31. Then, event data for any of the detected output data may be submitted to the presentation unit 10.

The processing device 32 may be adapted to obtain the event data based on feedback from the detector unit 31, e.g. an identifier of output data currently being presented. The obtained event data may be submitted by the processing device 32 to the presentation unit 10 through the communication unit 30.

The communication unit 30 may comprise a wireless transmitter, which is adapted to wirelessly communicate with the presentation unit 10. The wireless transmitter may e.g. be an IR (InfraRed) transmitter or a radio transmitter, such as a Bluetooth® or WLAN (Wireless Local Area Network) transmitter. Alternatively, the communication unit 30 can comprise a communication interface for wired connections, e.g. according to the EIA232 standard.

The detector unit 31, the processing unit 32, and the output data generation unit 34 may, for example, be implemented by one or several processors running software to provide their functions. Alternatively, the detector unit 31, the processing unit 32, and the output data generation unit 34 may be implemented using one or several ASICs (Application specific Integrated Circuit) or FPGAs (Field Programmable Gate Array).

The electronic apparatus 1 may, for example, be a portable or handheld mobile radio communication equipment, a mobile radio terminal, a mobile telephone, a pager, a communicator, an electronic organizer, or a smartphone.

FIG. 3 illustrates some components of the data presentation unit 10. The data presentation unit 10 may comprise a communication unit 40, a data unit 41, a memory 42 and the output device, here embodied as the display 11.

The communication unit 40 may be adapted according to the same principles as communication unit 30, i.e. may be an interface for wired or wireless communication. The communication unit 40 is adapted to receive the event data.

The data unit 41 is adapted to obtain the complementary data, e.g. as described above, based on received event data. Furthermore, the data unit 41 may be adapted to process the obtained complementary data. The data unit 41 may, for example, be implemented by a processor, an ASIC, or an FPGA.

Any downloaded complementary data may be temporarily stored in the memory 42. Alternatively or additionally, the memory 42 may comprise the complementary data. Thus, the memory 42 may implement the data repository for storing the complementary data. The memory 42 may e.g. be a memory card, a memory stick, a CD (Compact Disc), a DVD (a Digital Video Disc), a hard disc, or a ROM (Read Only Memory). Consequently, if necessary, the presentation unit 10 may comprise a memory card reader and/or a disc drive for CD/DVD.

The presentation unit 10 may, for example, be provided by a computer, such as a desktop or laptop computer. Alternatively, the presentation unit may be a TV and/or other display having communication capabilities. The communication capabilities may be provided by an adapter for communicating and obtaining the complementary data. The adapter may, for example, comprise a memory card reader. The adapter may be adapted for wireless communication, such as Bluetooth®. The adapter may be connectable to a SCART contact of the TV or display.

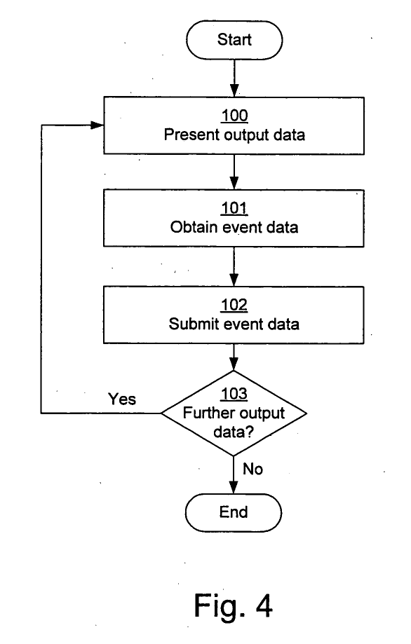

FIG. 4 illustrates methods for enabling presentation of complementary data. At block 100, output data is presented via the output device of the electronic apparatus 1. Then, at block 101, event data, which is associated with the presented output data and based on which the complementary data is obtainable, is obtained. The event data may be obtained based on a detection made of which output data is presented. Alternatively, the event data, such as an identifier, may be automatically generated when output data is presented. At block 102, the obtained event data is submitted to the data presentation unit 10. At block 103, it is determined whether any further output data is to be presented. If the answer at block 103 is yes, the procedure returns to step 100. If the answer at block 103 is no, the procedure is ended.

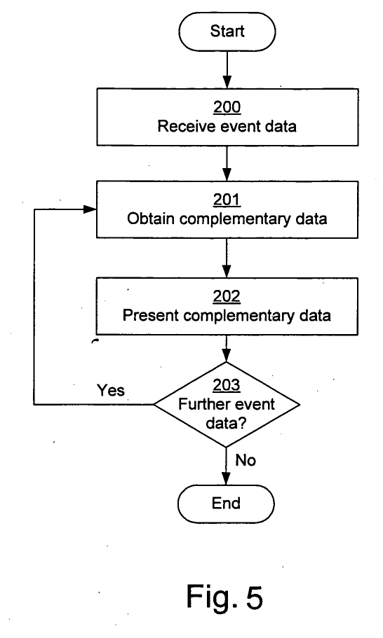

FIG. 5 illustrates methods for presenting complementary data. At block 200, the event data is received. At block 201, the complementary data is obtained, e.g. as described above, based on the received event data. At block 202, the obtained complementary data is presented. At block 203, it is determined whether any further event data has been received. If the answer at block 203 is yes, the procedure returns to step 201. If the answer at block 203 is no, the procedure is ended.

Embodiments of the present invention may be embedded in computer program products, which enable implementation of the methods and functions described herein. Embodiments of the present invention may be carried out when the computer program products are loaded and run in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

A computer program product may comprise computer program code means for executing the method, as defined in the description and the appended claims, for enabling presentation of complementary data associated with output data presented in an electronic apparatus, when the computer program code means are run by an electronic device having computer capabilities.

A computer readable medium may have stored thereon a computer program product comprising computer program code means for executing the method, as defined in the description and the appended claims, for enabling presentation of complementary data associated with output data presented in an electronic apparatus, when the computer program code means are run by an electronic device having computer capabilities.

A computer program product comprising computer program code means for executing the method, as defined in the description and the appended claims, for presenting complementary data in a data presentation unit, when the computer program code means are run by an electronic device having computer capabilities.

A computer readable medium having stored thereon a computer program product comprising computer program code means for executing the method, as defined in the description and the appended claims, for presenting complementary data in a data presentation unit, when the computer program code means are run by an electronic device having computer capabilities.

Some embodiments of the present invention allow for presentation of output data and complementary data, which is associated with the output data, substantially simultaneously. This may be useful if it is required that the output data is presented on the entire display area of a display to be legible. The complementary data may guide the user in the operation of the electronic apparatus 1. Thus, the overall experience of using the electronic apparatus 1 may be enhanced. Also, some embodiments of the present invention allow for reduced power consumption, e.g. when excess entering and re-entering into/out from displayed menus/user applications. Also, some embodiments of the present invention provision relevant complementary data at a desired time, presented in a desired way, and by a desired presentation unit (as the output device of the electronic apparatus 1 is busy). Furthermore, some embodiments of the invention provide for decreased storage requirements in the electronic apparatus 1 and/or the presentation unit 10.

The present invention is described with reference to flowchart illustrations and/or block and/or flow diagrams of methods according to embodiments of the invention. It should be noted that the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. It will be understood that each block of the flowchart illustrations and/or block diagrams, and combinations of blocks in the flowchart illustrations and/or block diagrams, can be implemented by computer program instructions.

These computer program instructions may also be stored in a computer-readable memory that can direct a computer or other programmable processor to function in a particular manner, such that the instructions stored in the computer-readable memory produce an article of manufacture including instruction means which implement the function/act specified in the flowchart and/or block diagram block or blocks.

As used herein, the singular forms “a”, “an” and “the” are intended to include the plural forms as well, unless expressly stated otherwise. In addition, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and/or the relevant art, and will not be interpreted in an idealized or overly formal sense unless expressly so defined herein.

The present invention has been described above with reference to specific embodiments. However, other embodiments than the above described are equally possible within the scope of the invention. Different method steps than those described above, performing the method by hardware or software, may be provided within the scope of the invention. The different features and steps of the invention may be combined in other combinations than those described. The scope of the invention is only limited by the appended patent claims.

What is claimed is:

1. A method for enabling presentation of complementary data associated with output data presented in an electronic apparatus, the method comprising:
presenting the output data via an output device of the electronic apparatus;
obtaining event data associated with the presented output data, wherein the complementary data is obtainable from the event data; and
submitting the event data to a data presentation unit external to the electronic apparatus.

2. The method according to claim 1, wherein obtaining the event data comprises obtaining event data that identifies at least a portion of the presented output data and that identifies the complementary data, wherein the complementary data is stored in a data repository located externally to the electronic apparatus.

3. The method according to claim 1, wherein obtaining the event data comprises obtaining event data associated with a user application for which the output data is presented.

4. The method according to claim 1, wherein obtaining the event data comprises obtaining event data associated with a menu for which the output data is presented.

5. The method according to claim 1, wherein obtaining the event data comprises obtaining event data that comprises the complementary data.

6. A method for presenting complementary data in a data presentation unit, the method comprising:
receiving, from an electronic apparatus located externally to the data presentation unit, event data associated with output data presented in the electronic apparatus;
obtaining complementary data associated with the output data based on the event data; and
presenting the obtained complementary data.

7. The method according to claim 6, wherein obtaining the complementary data comprises obtaining the complementary data from a data repository based on the event data, wherein the event data comprises an identifier for identifying the complementary data.

8. The method according to claim 6, wherein the obtaining the complementary data comprises obtaining the complementary data from a data repository.

9. An electronic apparatus for enabling presentation of complementary data associated with output data, comprising:
an output device configured to present the output data;
a detector unit configured to detect the presented output data; and
a processing unit configured to obtain event data associated with the presented output data, wherein the complementary data is obtainable from the event data, and wherein the processing unit is configured to submit the event data to a data presentation unit located externally to the electronic apparatus.

10. The electronic apparatus according to claim 9, wherein the processing unit is configured to obtain event data that identifies at least a portion of the presented output data and that identifies the complementary data, wherein the complementary data is stored in a data repository located externally to the electronic apparatus.

11. The electronic apparatus according to claim 9, wherein the processing unit is configured to obtain event data associated with a user application.

12. The electronic apparatus according to claim 9, wherein the processing unit is configured to obtain event data associated with a menu.

13. The electronic apparatus according to claim 9, wherein the processing unit is configured to obtain event data comprising the complementary data.

14. The electronic apparatus according to claim 9, wherein the electronic apparatus comprises a portable and/or handheld mobile radio communication equipment, a mobile radio terminal, a mobile telephone, a pager, a communicator, an electronic organizer, and/or a smartphone.

15. A data presentation unit for presenting complementary data, comprising:
a communication unit configured to receive, from an electronic apparatus located externally to the presentation unit, event data associated with output data presented in the electronic apparatus;
a data unit configured to obtain complementary data associated with the output data based on the event data; and
an output device configured to present the obtained complementary data.

16. The presentation unit according to claim 15, wherein the data unit is configured to obtain the complementary data from a data repository based on the event data, and wherein the event data comprises an identifier for identifying the complementary data.

17. The presentation unit according to claim 15, wherein the data unit is configured to obtain the complementary data from a data repository.

18. A computer program product for enabling presentation of complementary data associated with output data presented in an electronic apparatus, the computer program product comprising computer program code configured to execute the method according to claim 1.

19. A computer readable storage medium having stored thereon a computer program product for enabling presentation of complementary data associated with output data presented in an electronic apparatus, the computer program product comprising computer readable program code configured to carry out the method according to claim 1.

20. A computer program product for presenting complementary data in a data presentation unit, the computer program product comprising computer program code configured to execute the method according to claim 6.

21. A computer readable storage medium having stored thereon a computer program product for presenting complementary data in a data presentation unit, the computer program product comprising computer readable program code configured to carry out the method according to claim 6.
